(19) United States
(12) Patent Application Publication
(10) Pub. No.: US 2011/0102270 A1
(43) Pub. Date: May 5, 2011

(54) ANTENNA AND COMMUNICATION DEVICE EQUIPPED WITH THE SAME

(75) Inventors: Yasuki NAGATOMO, Miyazaki (JP); Kenichi KOZAKI, Miyazaki (JP); Kazuhide GOTOU, Miyazaki (JP)

(73) Assignee: PANASONIC CORPORATION, Osaka (JP)

(21) Appl. No.: 12/915,163

(22) Filed: Oct. 29, 2010

(30) Foreign Application Priority Data
Oct. 30, 2009 (JP) 2009-249789

(51) Int. Cl. H01Q 1/38

(52) U.S. Cl. 343/700 MS

(57) ABSTRACT

An antenna comprises the followings: a base substance provide on a substrate 8; a conductive film made on the base substance; and a gap 5 that electrically divides the conductive film into a first conductive film 6 and a second conductive film 7. The first conductive film 6 is connected to a power supply section provided on the substrate 8, and the second conductive film 7 is connected to a ground section 9 by way of a conductor. The power supply section, the first conductive film 6, the gap 5, the second conductive film 7, a conductor 11, and the ground section 9 are serially connected in this sequence.

### BACKGROUND

1. Field of the Invention

The present invention relates to an antenna used in electronic equipment, such as a portable phone, and a communication device equipped with the antenna.

2. Description of the Related Art

A chip antenna has hitherto been used as an antenna to be used in electronic equipment, such as a portable phone. One terminal of the antenna is supplied with electric power, and the other terminal of the antenna is taken as an open terminal (see; for instance, Patent Document 1).
Patent Document 1: JP-A-11-31913

However, according to the related art technique, the other terminal is taken as an open terminal. Therefore, when a metallic plate or a ground is placed in the vicinity of the chip antenna, there arise problems of deterioration of a communication characteristic of the antenna chip and the antenna chip being influenced by the outside.

Further, when an attempt is made to lessen the influence of the outside, the size of the chip antenna itself becomes greater, which in turn hinders miniaturization of the entire device equipped with the chip antenna.

Accordingly, in light of the foregoing related art problem, the present invention aims at providing an antenna that is reduced in size and that is resistant to the influence of the outside and a communication device equipped with the antenna.

### SUMMARY

In order to solve the problem, the present invention provides an antenna comprising the followings: a base substance placed on a substrate; a conductive film made on the base substance; and a gap that electrically divides the conductive film into a first conductive film and a second conductive film and that includes a capacitive component, wherein the first conductive film is connected to a power supply section placed on the substrate; the second conductive film is connected to a ground section by way of a conductor; and the power supply section, the first conductive film, the gap, the second conductive film, the conductor, and the ground section are serially connected in this sequence. An antenna that is less susceptible to external influence while reduced in size can thereby be provided.

### BRIEF DESCRIPTION OF THE DRAWINGS

FIG. 1 is an overview of an antenna of a first embodiment of the present invention;

FIG. 2 is an overview of the antenna of the first embodiment of the present invention;

FIG. 3 is a circuit diagram of the antenna of the first embodiment of the present invention;

FIGS. 4A and 4B are characteristic graphs of the antenna of the first embodiment of the present invention;

FIG. 5 is an overview of the antenna of the first embodiment of the present invention;

FIG. 6 is an overview of the antenna of the first embodiment of the present invention;

FIG. 7 is an overview of an antenna of a second embodiment of the present invention;

FIG. 8 is an overview of the antenna of the second embodiment of the present invention; and

FIG. 9 is a circuit diagram of the antenna of the second embodiment of the present invention.

### DETAILED DESCRIPTION

A first aspect of the invention is directed toward an antenna comprising the followings: namely, a base substance placed on a substrate; a conductive film made on the base substance; and a gap that electrically divides the conductive film into a first conductive film and a second conductive film and that includes a capacitive component, wherein the first conductive film is connected to a power supply section placed on the substrate; the second conductive film is connected to a ground section by a conductor; and the power supply section, the first conductive film, the gap, the second conductive film, the conductor, and the ground section are serially connected in this sequence. Specifically, by means of such a structure, the antenna can acquire a capacitive component, and an impedance component and the capacitive component can be implemented in the form of one chip. Accordingly, the antenna does not need to be provided with an external capacitor. In particular, in the present patent application, one end of the antenna is connected to the ground section. Therefore, variations in capacitive component pose great influence on the antenna. However, the capacitive component is produced by providing the conductive film with only a gap, so that variations can be kept smaller. When compared especially with a case where a capacitor is formed opposite a pair of electrodes, variation factors, such as a positional displacement, can be obviously diminished. Moreover, the capacitive component can be changed by mere change of a gap length, so that a communication frequency can be simply adjusted. As a consequence, the antenna can be made less susceptible to influence of the ground section and stable in terms of a communication frequency.

A second aspect of the invention is based on the antenna defined in the first aspect of the invention and further includes the followings: namely, a third conductive film and a fourth conductive film made on the base substance; and another gap that is provided between the third conductive film and the fourth conductive film that includes a capacitive component, wherein the first conductive film and the third conductive film are connected to the power supply section placed on the substrate; the fourth conductive film is connected to another ground section by way of another conductor; and the power supply section, the third conductive film, the other gap, the fourth conductive film, the other conductor, and the ground section are serially connected in this sequence. It is thereby possible to transmit and receive a plurality of frequencies by means of one antenna.

A third aspect of the invention is based on the antenna defined in a second aspect of the invention, wherein the other ground section is connected to the ground section. Different frequencies can be easily adjusted.

Moreover, a fourth aspect of the invention is based on the antenna defined in the first aspect of the invention and further includes the followings: namely, a third conductive film and a fourth conductive film made on the base substance; and another gap that is provided between the third conductive film and the fourth conductive film that includes a capacitive component, wherein the third conductive film is connected to another power supply section placed on the substrate; the fourth conductive film is connected to the ground section by way of another conductor; and the power supply section, the third conductive film, the other gap, the fourth conductive film, the other conductor, and the ground section are serially connected in this sequence. It becomes possible for one antenna to transmit and receive a plurality of frequencies.

Further, a fifth aspect of the invention is based on the antenna defined in a fourth aspect of the invention, wherein the other conductor is integrally connected to the conductor. Different frequencies can be easily adjusted.

Furthermore, an invention defined in a sixth aspect of the invention is based on the antenna defined in the first aspect of the invention, wherein a surface area of the first conductive film and a surface area of the second conductive film are substantially identical with each other. An inductive component of the first conductive film and an inductive component of the second conductive film become thereby substantially equal to each other. A desired inductive component can be acquired even when the antenna is directed in any orientation.

Moreover, a seventh aspect of the invention is based on the antenna defined in the second aspect of the invention, wherein a surface area of the third conductive film and a surface area of the fourth conductor are substantially identical with each other. An inductive component of the third conductive film and an inductive component of the fourth conductive film become thereby substantially equal to each other. A desired inductive component can be acquired even when the antenna is directed in any orientation.

Further, an eighth aspect of the invention is based on the antenna defined in the sixth aspect of the invention, wherein a surface geometry of the first conductive film and a surface geometry of the second conductive film are symmetrical about the gap and substantially identical with each other. An inductive component of the first conductive film and an inductive component of the second conductive film become substantially equal to each other with superior accuracy. A desired inductive component can be acquired even when the antenna is directed in any orientation.

Furthermore, a ninth aspect of the invention is based on the antenna defined in the seventh aspect of the invention, wherein a surface geometry of the third conductive film and a surface geometry of the fourth conductive film are symmetrical about the gap and substantially identical with each other. An inductive component of the third conductive film and an inductive component of the fourth conductive film become substantially equal to each other with superior accuracy. A desired inductive component can be acquired even when the antenna is directed in any orientation.

Moreover, a tenth aspect of the invention is based on the antenna defined in the first aspect of the invention, wherein a surface area of the first conductive film and a surface area of the second conductive film differ from each other. The magnitude of the inductive component of the first conductive film or the magnitude of the inductive component of the second conductive film can be changed easily while the size of the antenna is made constant.

Further, an eleventh aspect of the invention is based on the antenna defined in the second aspect of the invention, wherein a surface area of the third conductive film and a surface area of a fourth conductive film differ from each other. The magnitude of the inductive component of the third conductive film or the magnitude of the inductive component of the fourth conductive film can be changed easily while the size of the antenna is made constant.

Furthermore, a twelfth aspect of the invention is based on the antenna defined in the second aspect of the invention, wherein a width of the gap and a width of the other gap differ from each other. The communication frequency “f” and the communication frequency “f” can be easily set to different values, and different frequencies can be easily adjusted.

Moreover, a thirteenth aspect of the invention is based on the antenna of the second aspect of the invention, wherein a length of the gap differs from a length of the other gap. The communication frequency “f” and the communication frequency “f” can thereby be easily set to different values, and different frequencies can be easily adjusted.

Further, a fourteenth aspect of the invention is based on the antenna defined in the fourth aspect of the invention, wherein a surface area of a third conductive film and a surface area of a fourth conductive film are substantially identical with each other. An inductive component of the third conductor and an inductive component of the fourth conductor become thereby substantially equal to each other. A desired inductive component can be acquired even when the antenna is directed in any orientation.

Furthermore, a fifteenth aspect of the invention is based on the antenna defined in the fourth aspect of the invention, wherein a width of the gap and a width of the other gap differ from each other. The communication frequency “f” and the communication frequency “f” can thereby be easily set to different values, and different frequencies can be easily adjusted.

Moreover, a sixteenth aspect of the invention is based on the antenna defined in the fourth aspect of the invention, wherein a length of the gap differs from a length of the other gap. The communication frequency “f” and the communication frequency “f” can thereby be easily set to different values, and different frequencies can be easily adjusted.

Further, a seventeenth aspect of the invention is based on the antenna defined in the first aspect of the invention, wherein the gap linearly goes around a surface of the conductive film by a shortest way. The inductive component of the first conductor and the inductive component of the second conductor can thereby be set with high accuracy.

Furthermore, an eighteen aspect of the invention is based on the antenna defined in the first aspect of the invention, wherein the gap goes around a surface of the conductive film in a stepwise folded way. A capacitive component stemming from a gap can be easily changed while the size of the antenna is kept constant.

Moreover, a nineteenth aspect of the invention defined is directed toward an antenna and includes the followings: namely, a base substance provided on a substrate; a conductive film made on the base substance; and a gap that electrically divides the conductive film into a first conductive film and a second conductive film, wherein the first conductive film is connected to a power supply section; the second conductive film is connected to a ground section; and the power supply section, the first conductive film, the gap, the second conductive film, and the ground section are connected in series.

A twentieth aspect of the invention is directed toward a communication device and includes the followings: namely, a substrate; a base substance provided on the substrate; a conductive film made on the base substance; and a gap that electrically divides the conductive film into a first conductive film and a second conductive film, wherein the first conductive film is connected to a power supply section; the second conductive film is connected to a ground section; and the power supply section, the first conductive film, the gap, the second conductive film, and the ground section are connected in series.

### EMBODIMENTS

Embodiments of the present invention are described hereunder by reference to the drawings.

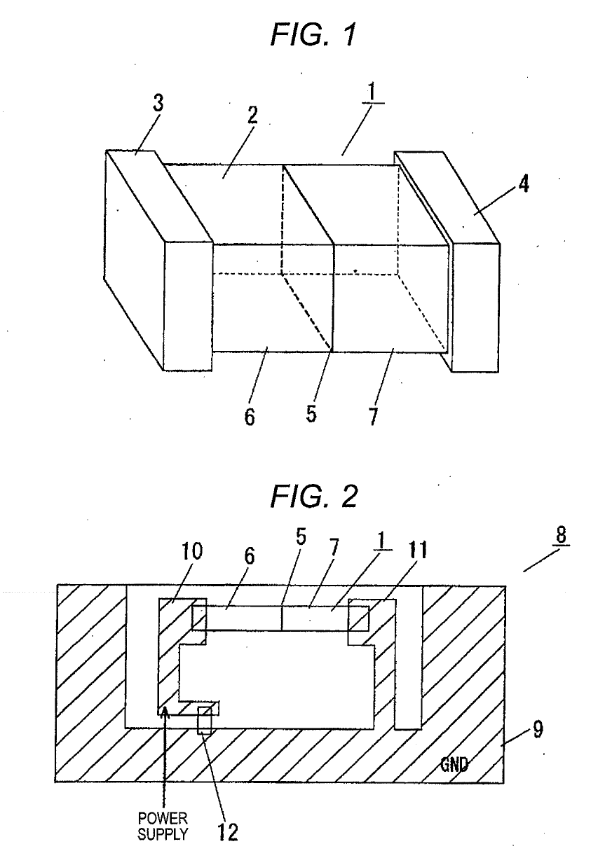

An antenna of the present invention is described by reference to FIGS. 1 and 2. FIG. 1 is an overview of the antenna of the first embodiment of the present invention, and FIG. 2 is an overview of the antenna of the first embodiment of the present invention.

In FIG. 1, a chip antenna 1 includes a base substance 2 having a conductive film formed over an entire surface of the base substance, terminals 3 and 4 provided at both ends of the base substance 2, and a gap 5 made along a periphery of the base substance 2. The gap 5 separates the conductive film formed over the base substance 2 into a first conductive film 6 adjoining the terminal 3 and a second conductive film 7 adjoining the terminal 4.

The chip antenna 1 assumes a square shape measuring 1 mm×1 mm and a length of 5 mm; however, another shape may also be adopted.

The thickness of the conductive film formed over the base substance 2 ranges from 4 μm to 24 μm, and an average thickness is 16 μm. Spacing of the gap 5 ranges from 15 to 1000 μm and assumes a value of 20 μm in the embodiment.

The gap 5 is also disposed at a center area of the chip antenna 1 in the present embodiment; however, the location of the gap can appropriately be changed according to a design.

The base substance 2 is now described in detail. The base substance 2 is made of an insulating material. A material, such as, barium titanate, alumina, a material containing alumina as a chief ingredient, and silicon oxide, is preferably used as a constituent material of the base substance 2. Use of alumina or a material containing alumina as a chief ingredient makes it possible to produce an electronic component compatible with a high frequency. The electronic component also exhibits high strength and ease of machining. Alumina is used in the present embodiment.

The conductive film is made of a conductive material, such as copper, silver, gold, and nickel, in the form of a single layer or a plurality of layers. A conductive surface is made on the conductive film. Evaporation, sputtering, a paste, a CVD technique, or a printing technique is used for the conductive film. In the present embodiment, a conductive film is made by means of copper plating.

In the present embodiment, after formation of the conductive film, the gap 5 is made by means of laser trimming while the base substance 2 is being rotated. However, another technique, such as etching, can also be taken.

In FIG. 1, the base substance 2 is depicted in a square shape but may assume a columnar shape or a polygonal column.

Although the conductive film is formed over the entire surface of the base substance 2 in the present embodiment, the conductive film may also be formed over the entire periphery of the base substance except end faces of the respective terminals 3 and 4, so long as the first conductive film 6 and the second conductive film 7 can be formed.

Further, the chip antenna 1 can also be manufactured by making a conductive film over one surface of a flat plate and also making a gap in the conductive film.

In the present embodiment, in order to facilitate mounting operation when the chip antenna is mounted on a substrate, a step height is provided in the chip antenna, thereby making the first conductive film 6 and the second conductive film 7 lower than the terminals 3 and 4.

FIG. 2 is a drawing showing the chip antenna 1 mounted on a substrate 8. A land pattern is laid on the substrate 8. The land pattern includes a ground pattern 9 laid along a periphery of the substrate 8, a conductor pattern 10 which is to be connected to the terminal 3, and a conductor pattern 11 which is to be connected to the terminal 4.

The chip antenna 1 is mounted on the substrate 8, and the conductor pattern 10 is supplied with electric power from an un-illustrated power supply section, whereby the chip antenna 1 is supplied with electric power. The conductor pattern 10 is connected to the ground pattern 9 by way of a matching element 12. The conductor pattern 11 is connected to the terminal 4 and the ground pattern 9, thereby connecting the chip antenna 1 to a ground.

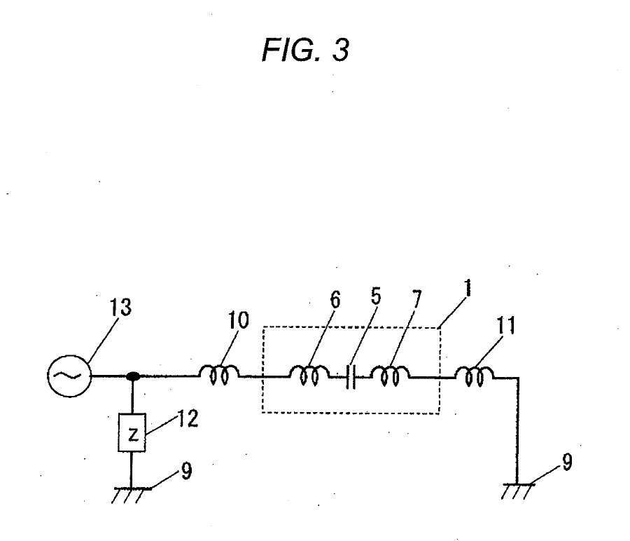

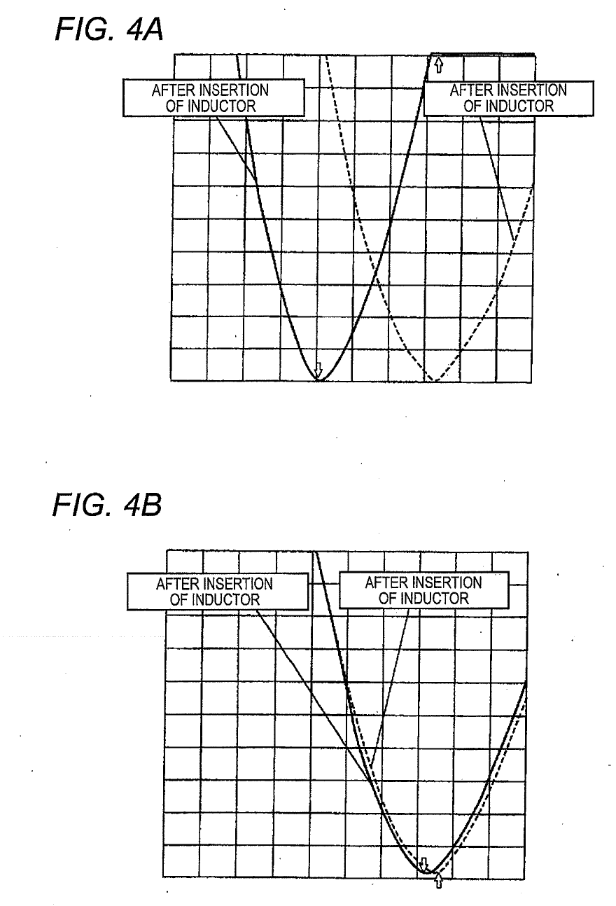

Operation of the antenna having the configuration is now described by reference to FIGS. 3, 4A and 4B. FIG. 3 is a circuit diagram of the antenna of the first embodiment of the present invention, and FIGS. 4A and 4B are characteristic graphs of the antenna of the first embodiment of the present invention. A circuit diagram shown in FIG. 3 is an equivalent circuit diagram for a high frequency; for instance, 1.5 GHz (GPS) and 2.4 GHz.

The high frequency described in connection with the present embodiment is not limited to the frequencies and also includes frequencies used in portable phones that are 600 MHz or more.

As shown in FIG. 3, in the antenna that transmits and receives the high frequency, the first conductive film 6 of the chip antenna 1, the conductor pattern 10 that electrically connects the second conductive film 7 and the power supply section to the terminal 3, and the conductor pattern 11 that electrically connects the terminal 4 to the ground pattern 9 can be deemed as a coil.

In FIG. 3, a power supply section 13 that supplies electric power to the chip antenna 1, the conductor pattern 10, the first conductive film 6, the gap 5, the second conductive film 7, the conductor pattern 11, and the ground pattern 9 are serially connected in this sequence. The matching element 12 is interposed between the power supply section 13 and the conductor pattern 10, and the matching element 12 is connected to the ground pattern 9, as well.

In relation to the circuit configuration provided above, provided that a capacitive component of the gap 5 is C; that an inductive component of the second conductive film 7 is L1; and an inductive component of the conductor pattern 11 is L2, a frequency “f” of the antenna of the present embodiment is expressed (by Mathematical Formula 1).

$$f = \frac{1}{2 π \sqrt{( {L}_{1} + {L}_{2} ) C}} \qquad [ Mathematical Formula 1 ]$$

The inductive component existing in an area which extends from the power supply section 13 to the gap 5 does not substantially affect a communication frequency of the antenna of the present embodiment. The communication frequency is determined by the capacitive component and the inductive component existing in the area which extends from the gap 5 to the ground pattern 9; namely, the gap 5, the second conductive film 7, and the conductor pattern 11.

The fact that the inductive component existing in the area which extends from the power supply section 13 to the gap 5 does not substantially affect the communication frequency is now described by reference to FIGS. 4A and 4B. FIGS. 4A and 4B are characteristic graphs of the antenna of the first embodiment of the present invention.

In FIGS. 4A and 4B, the chip antenna 1 is used and mounted as illustrated in FIG. 2, and a land pattern is given a size of 3 mm×8 mm.

FIG. 4A is a frequency graph acquired when a 2.7 nH chip inductor is inserted between the terminal 4 and the ground pattern 9, wherein a horizontal axis represents a frequency.

A frequency acquired before insertion of the chip inductor was 2167 MHz. However, after insertion of the chip inductor, the frequency came to 2008 MHz. It is seen that a frequency fluctuation of 159 MHz occurred as a result of insertion of the chip inductor.

FIG. 4B is a frequency graph acquired when a 2.7 nH chip inductor is inserted between the power supply section 13 and the terminal 3, and a horizontal axis represents a frequency.

A frequency acquired before insertion of the chip inductor was 2168 MHz. However, after insertion of the chip inductor, the frequency came to 2161 MHz. It is seen that a frequency fluctuation of 7 MHz occurred as a result of insertion of the chip inductor.

In short, when the chip inductor is inserted between the terminal 4 and the ground pattern 9; namely, an area extending from the gap 5 to the ground pattern 9, the frequency greatly fluctuates. On the contrary, when the chip inductor is inserted between the power supply section 13 and the terminal 3; namely, the power supply section 13 and the gap 5, the frequency hardly fluctuates. It is understood that an inductive component existing in the area between the power supply section 13 and the gap 5 can almost be ignored when the frequency of the antenna is determined and that the frequency is defined as mentioned above (as expressed in Formula 1).

The frequency of the antenna is determined as mentioned above, and hence a characteristic point of the embodiment is described in detail below.

In the embodiment, the chip antenna 1 has a capacitive component C of the gap 5 and the inductive component L1 of the second conductive film 7 that determine the frequency of the antenna. Therefore, a chip antenna having a desired frequency can be manufactured by adjusting the values.

The frequency can easily be adjusted by means of adjusting only the chip antenna 1 without involvement of a change in the conductor pattern 11 laid on the substrate 8.

In particular, the chip antenna 1 of the present embodiment is fabricated by means of forming a conductive film on the surface of the base substance 2 by means of plating and subjecting the film to laser trimming. Hence, the inductive component L1 can be changed by means of changing only the position of laser trimming. Further, the capacitive component C can readily be changed by changing a width of laser trimming, so that the chip antenna can be tuned for a desired frequency.

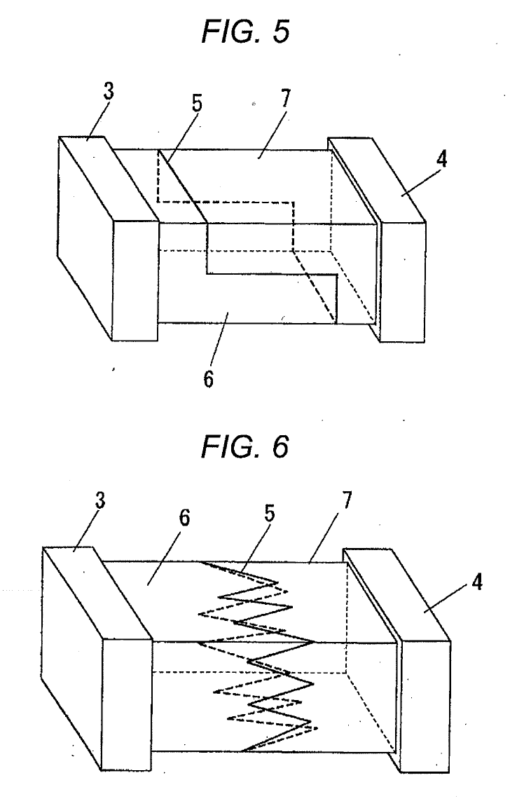

A geometry of the gap 5 of the chip antenna 1 is now described by reference to FIGS. 5 and 6. FIG. 5 is an overview of the antenna of the first embodiment of the present invention, and FIG. 6 is an overview of the antenna of the first embodiment of the present invention.

In FIG. 5, in order to elongate a gap path which is to be made by laser trimming and gain a capacitive component of the gap 5, the base substance 2 is once trimmed along its longitudinal direction, thereby creating the step-like gap 5.

In FIG. 6, in order to elongate the gap path which is to be made by laser trimming and gain the capacitive component of the gap 5 in the same manner as described above, the gap 5 is formed in a zigzag pattern.

By means of the foregoing operations, the capacitive component of the gap can be increased without involvement of a change in the size of the chip antenna 1. Hence, the chip antenna is useful when a frequency is adjusted to a comparatively lower frequency.

### Second Embodiment

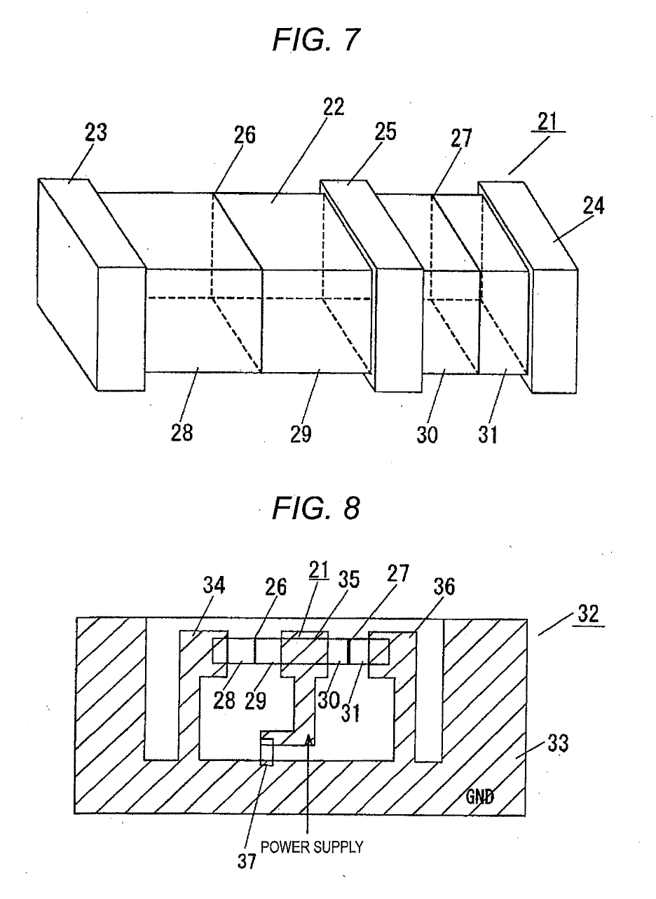

A second embodiment is directed toward a case where the chip antenna is made compliant with two frequencies and described by reference to FIGS. 7 through 9. A reference is made to the first embodiment in connection with elements similar to those described in connection with the first embodiment.

FIG. 7 is an overview of the antenna of the second embodiment of the present invention, and FIG. 8 is an overview of the antenna of the second embodiment of the present invention.

As shown in FIG. 7, in the present embodiment, the antenna includes two chip antennas coupled together. A chip antenna 21 includes a base substance 22 having a conductive film formed over an entire surface of the base substance, terminals 23 and 24 provided at both ends of the base substance 22, a terminal 25 interposed between the terminals 23 and 24, a gap 26 interposed between the terminals 23 and 25, and a gap 27 interposed between the terminals 24 and 25.

The conductive film formed on the base substance 22 is divided into, in sequence from the terminal 23, a first conductive film 28, a second conductive film 29, a third conductive film 30, and a fourth conductive film 31 by means of the gap 26, the terminal 25, and the gap 27.

The chip antenna 21 assumes a square shape measuring 1 mm×1 mm and a length of 8 mm. A length between the terminal 23 to the terminal 25 is 5 mm, and a length between the terminal 25 to the terminal 24 is 3 mm. Other sizes can also be adopted.

FIG. 8 is a view showing the chip antenna 21 mounted on a substrate 32. A land pattern is made on the substrate 32. The land pattern includes a ground pattern 33 laid along a periphery of the substrate 32, a conductor pattern 35 connecting the terminal 23 to the ground pattern 33, a conductor pattern 34 connected to the terminal 25, and a conductor pattern 36 connecting the terminal 24 to the ground pattern 33.

The chip antenna 21 is mounted on the substrate 32, and the conductor pattern 35 is supplied with electric power from an unillustrated power supply section, and the electric power is supplied further to the chip antenna 21. The conductor pattern 35 is connected to the ground pattern 33 by way of a matching element 37.

The chip antenna 21 of the present embodiment is compliant to two frequencies. In the present embodiment, a portion (a left half) of the chip antenna extending from the terminal 23 to the terminal 25 acts as a GPS antenna for 1.5 GHz (hereinafter taken as a first frequency), and a portion (a right half) of the chip antenna extending from the terminal 25 to the terminal 24 acts as an antenna for 2.4 GHz (hereinafter taken as a second frequency).

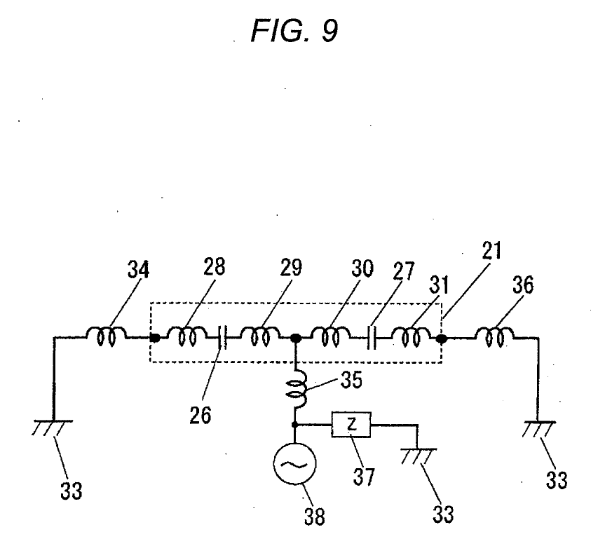

Operation of the antenna having the above configuration is hereunder described by reference to FIG. 9. FIG. 9 is a circuit diagram of the antenna of the second embodiment of the present invention. The circuit diagram of FIG. 9 is an equivalent circuit diagram for high frequencies.

As shown in FIG. 9, in the antenna that transmits and receives high frequencies, the first conductive film 28, the second conductive film 29, the third conductive film 30, the fourth conductive film 31, the conductor pattern 34, the conductor pattern 35, and the conductor pattern 36 of the chip antenna 21 can be deemed as a coil.

In FIG. 9, when the left half of the chip antenna 21 is first viewed, a power supply section 38 that supplies electric power to the chip antenna 21, the conductor pattern 35, the second conductive film 29, the gap 26, the first conductive film 28, the conductor pattern 34, and the ground pattern 33 are, in this order, serially connected together.

In the configuration, provided that a capacitive component of the gap 26 is C1; an inductive component of the first conductive film 28 is L1; and that an inductive component of the conductor pattern 34 is L2, a frequency that is transmitted and received by the left half of the chip antenna 21; namely, the frequency f1 is expressed by (Mathematical Formula 2). The first frequency is transmitted and received by means of the configuration of the left half of the chip antenna 21.

$${f}_{1} = \frac{1}{2 π \sqrt{( {L}_{1} + {L}_{2} ) {C}_{1}}} \qquad [ Mathematical Formula 2 ]$$

In FIG. 9, when the right half of the chip antenna 21 is viewed, the power supply section 38 that supplies electric power to the chip antenna 21, the conductor pattern 35, the third conductive film 30, the gap 27, the fourth conductive film 31, the conductor pattern 36, and the ground pattern 33 are, in this order, serially connected together.

In the configuration, provided that a capacitive component of the gap 27 is C2; an inductive component of the fourth conductive film 31 is L3; and that an inductive component of the conductor pattern 36 is L4, the frequency transmitted and received by the right half of the chip antenna 21; namely, the frequency f2, is expressed by (Mathematical Formula 3). The second frequency is transmitted and received by means of the configuration of the right half of the chip antenna 21.

$${f}_{2} = \frac{1}{2 π \sqrt{( {L}_{3} + {L}_{4} ) {C}_{2}}} \qquad [ Mathematical Formula 3 ]$$

In the present embodiment, the antennas for two frequencies can be implemented as one chip by means of the configuration.

A relationship between the first frequency and the second frequency is described in detail.

In the present embodiment, the first frequency is 1.5 GHz, and the second frequency is 2.4 GHz. Further, the second frequency is 1.6 times as high as the first frequency. Therefore, in order to implement the antenna in the form of one chip, the terminal 25 is placed closer to the terminal 24. Further, the length of an area from an end facing the terminal 23 of the first conductive film 28 to an end facing the terminal 25 of the second conductive film 29 is made longer than the length of an area from an end facing the terminal 25 of the third conductive film 30 to an end facing the terminal 24 of the fourth conductive film 31. Thus, the inductive component of the left half of the chip antenna is assured.

When a ratio of the first frequency to the second frequency is greater than that mentioned in connection with the present embodiment, the difference between the first frequency and the second frequency cannot be implemented by a difference between the inductive components. Hence, a greater capacitive component must be assured by adoption of geometries such as those shown in FIGS. 5 and 6.

When gaps 26 and 27 are made in the same width, adjustment is performed by means of the inductive component. Therefore, as shown in FIG. 7, the positions of the gaps 26 and 27 are not set in an approximate center area between terminals but shifted from the center by adjustment.

Moreover, when the gaps 26 and 27 are made in the same width, adjustment is performed by means of the inductive components. Since frequencies usually differ from each other, electric lengths (path lengths) from the gaps to the ground also differ from each other.

In the present embodiment, the terminal 25 is supplied with electric power. However, the terminals 23 and 24 on both ends of the antenna may also be supplied with electric power, and the terminal 25 may also be connected to a ground. In this case, the first frequency is determined by the gap 26, the second conductive film 29, and the conductor pattern 35. The second frequency is determined by the gap 27, the third conductive film 30, and the conductor pattern 35.

Specifically, when the left half of the chip antenna 21 is first viewed, the power supply section 38 that supplies electric power to the chip antenna 21, the conductor pattern 35, the second conductive film 29, the gap 26, the first conductive film 28, the conductor pattern 34, and the ground pattern 33 are, in this order, serially connected together.

In the configuration, provided that the capacitive component of the gap 26 is C1; the inductive component of the second conductive film 29 is L1; and that the inductive component of the conductor pattern 35 is L2, the frequency transmitted and received by the left half of the chip antenna 21; namely, the frequency f1, is expressed by (Mathematical Formula 4). The first frequency is transmitted and received by means of the configuration of the left half of the chip antenna 21.

$${f}_{1} = \frac{1}{2 π \sqrt{( {L}_{1} + {L}_{2} ) {C}_{1}}} \qquad [ Mathematical Formula 4 ]$$

In FIG. 9, when the right half of the chip antenna 21 is viewed, the power supply section 38 that supplies electric power to the chip antenna 21, the conductor pattern 35, the third conductive film 30, the gap 27, the fourth conductive film 31, the conductor pattern 36, and the ground pattern 33 are, in this order, serially connected together.

In the configuration, provided that the capacitive component of the gap 27 is C2; the inductive component of the third conductive film 30 is L3; and that the inductive component of the conductor pattern 35 is L4, the frequency transmitted and received by the right half of the chip antenna 21; namely, the frequency f2, is expressed by (Mathematical Formula 5). The second frequency is transmitted and received by means of the configuration of the right half of the chip antenna 21.

$${f}_{2} = \frac{1}{2 π \sqrt{( {L}_{3} + {L}_{4} ) {C}_{2}}} \qquad [ Mathematical Formula 5 ]$$

In the present embodiment, the antennas are made compatible with two frequencies. However, the chip antenna can also be made compatible with three frequencies or more by additional provision of terminals.

A chip antenna main body is provided with terminals that are greater in number than supported frequencies by one. Gaps are provided between the terminals, whereby a chip antenna compliant with a large number of frequencies can be provided.

The antenna of the present invention is particularly useful for a comparatively compact electronic device and a comparatively compact communication device, such as a portable phone and a PC like a notebook PC.

Specifically, an explanation is now given to; for instance, a case where the antennas shown in FIGS. 2 and 8 are incorporated in a portable phone; namely, a communication device.

Like a configuration of a related art portable terminal, the portable terminal includes a liquid crystal panel, operation buttons, enclosures, a substrate housed in the enclosures, a battery, and the like. The antennas of the present invention shown in FIGS. 2 and 8 are mounted on the respective substrates in the enclosures and secured to predetermined locations on the respective substrates. Components, such as an RF-ID IC, a matching circuit, an antenna for another frequency, a camera unit, a speaker, and an RF module, are placed in space between an enclosure 26 and a substrate 23. Superior communication can be carried out even when the components remain in: contact with or out of contact with the antenna of the present patent application. The antenna can also be provided on the enclosure.

Further, the antenna shown in FIG. 2 is used as an antenna for; for instance, 1.5 GHz (the GPS) or 2.4 GHz (e.g., the Bluetooth), and mounted in a communication device. As a matter of course, the frequency is not limited to those mentioned above and may also be a high frequency of 600 MHz or more used in a portable phone or a low frequency that is lower than 600 MHz. In the antenna shown in FIG. 8, a portion extending from the terminal 23 to the terminal 25 (the left half) acts as an antenna for 1.5 GHz (hereinafter taken as a first frequency) of the GPS, and a remaining portion extending from the terminal 25 to the terminal 24 (a right half) is used as an antenna for 2.4 GHz (hereinafter taken as a second frequency) of the Bluetooth. The antenna is mounted in a communication device. Naturally, the frequency is not limited to those mentioned above and can also be a high frequency of 600 MHz or more used in a portable phone and a low frequency that is lower than 600 MHz.

According to the present invention, it is possible to provide an antenna that is less susceptible to external influence while reduced in size. Therefore, the present invention is useful for an electronic device equipped with an antenna; particularly, a compact communication device, such as a portable phone.

This application claims the benefit of Japanese Patent application No. 2009-249789 filed on Oct. 30, 2009, the entire contents of which are incorporated herein by reference.

What is claimed is:

1. An antenna comprising:
a base substance placed on a substrate;
a conductive film made on the base substance; and
a gap that electrically divides the conductive film into a first conductive film and a second conductive film, the gap including a capacitance element;
wherein the first conductive film is connected to a power supply section placed on the substrate;
the second conductive film is connected to a ground section by a conductor; and
the power supply section, the first conductive film, the gap, the second conductive film, the conductor, and the ground section are serially connected in this sequence.

2. The antenna according to claim 1, further comprising:
a third conductive film and a fourth conductive film made on the base substance; and
another gap that is provided between the third conductive film and the fourth conductive film, the other gap including a capacitive component,
wherein the first conductive film and the third conductive film are connected to the power supply section placed on the substrate;
the fourth conductive film is connected to another ground section by another conductor; and
the power supply section, the third conductive film, the other gap, the fourth conductive film, the other conductor, and the ground section are serially connected in this sequence.

3. The antenna according to claim 2, wherein the other ground section is connected to the ground section.

4. The antenna according to claim 1, further comprising:
a third conductive film and a fourth conductive film made on the base substance; and
another gap that is provided between the third conductive film and the fourth conductive film, the other gap including a capacitive component,
wherein the third conductive film is connected to another power supply section placed on the substrate;
the fourth conductive film is connected to the ground section by another conductor; and
the power supply section, the third conductive film, the other gap, the fourth conductive film, the other conductor, and the ground section are serially connected in this sequence.

5. The antenna according to claim 4, wherein the other conductor is integrally connected to the conductor.

6. The antenna according to claim 1, wherein a surface area of the first conductive film and a surface area of the second conductive film are substantially identical with each other.

7. The antenna according to claim 2, wherein a surface area of a third conductive film and a surface area of a fourth conductive film are substantially identical with each other.

8. The antenna according to claim 6, wherein a surface geometry of the first conductive film and a surface geometry of the second conductive film are symmetrical about the gap and substantially identical with each other.

9. The antenna according to claim 7, wherein a surface geometry of the third conductive film and a surface geometry of the fourth conductive film are symmetrical about the gap and substantially identical with each other.

10. The antenna according to claim 1, wherein a surface area of the first conductive film and a surface area of the second conductive film differ from each other.

11. The antenna according to claim 2, wherein a surface area of the third conductive film and a surface area of a fourth conductive film differ from each other.

12. The antenna according to claim 2, wherein a width of the gap and a width of the other gap differ from each other.

13. The antenna according to claim 2, wherein a length of the gap differs from a length of the other gap.

14. The antenna according to claim 4, wherein a surface area of the third conductive film and a surface area of the fourth conductive film are substantially identical with each other.

15. The antenna according to claim 4, wherein a width of the gap and a width of the other gap differ from each other.

16. The antenna according to claim 4, wherein a length of the gap differs from a length of the other gap.

17. The antenna according to claim 1, wherein the gap linearly goes around a surface of the conductive film by a shortest way.

18. The antenna according to claim 1, wherein the gap goes around a surface of the conductive film in a stepwise folded way.

19. An antenna, comprising:
a base substance provided on a substrate;
a conductive film made on the base substance; and
a gap that electrically divides the conductive film into a first conductive film and a second conductive film, wherein
the first conductive film is connected to a power supply section;
the second conductive film is connected to a ground section;
and the power supply section, the first conductive film, the gap, the second conductive film, and the ground section are connected in series.

20. A communication device comprising:
a substrate;
a base substance provided on the substrate;
a conductive film made on the base substance; and
a gap that electrically divides the conductive film into a first conductive film and a second conductive film,
wherein the first conductive film is connected to a power supply section;
the second conductive film is connected to a ground section; and
the power supply section, the first conductive film, the gap, the second conductive film, and the ground section are connected in series.
